(19) United States
(12) Patent Application Publication
(10) Pub. No.: US 2025/0357617 A1
(43) Pub. Date: Nov. 20, 2025

(54) ENERGY STORAGE DEVICE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/095,035

(22) Filed: Mar. 31, 2025

(30) Foreign Application Priority Data
May 16, 2024 (JP) 2024-080283

(51) Int. Cl. H01M 50/358; B60K 6/28; B60L 50/64; B60L 58/26; H01M 10/613; H01M 10/625; H01M 10/647; H01M 50/209

(52) U.S. Cl. CPC H01M 50/358; H01M 10/613; H01M 10/625; H01M 10/647; H01M 50/209; B60K 6/28; B60L 50/64; B60L 58/26; B60Y 2200/92; H01M 2220/20

(57) ABSTRACT

An energy storage device includes a housing case having an opening, an energy storage module, a frame member covering the opening, and a cooler for cooling the energy storage module. The energy storage module includes an energy storage stack disposed adjacent to each other, and the frame member is disposed between the energy storage stacks disposed adjacent to each other, and a gas discharge path communicating with the opening is positioned inside the frame member, and the frame member is provided with an inlet hole for introducing gas discharged from any of the energy storage stacks disposed adjacent to each other into the gas discharge path, and the cooler is provided with a through hole at a position corresponding to the opening.

### CROSS-REFERENCE TO RELATED APPLICATION

This application claims priority to Japanese Patent Application No. 2024-080283 filed on May 16, 2024, incorporated herein by reference in its entirety.

### BACKGROUND

### 1. Technical Field

The present disclosure relates to energy storage devices mounted on vehicles.

### 2. Description of Related Art

WO2020/134054 discloses an energy storage device. In this energy storage device, a partition member (frame member) that separates areas for placing a plurality of energy storage stacks is a hollow member. This energy storage device has a structure in which a hollow portion of the hollow member is used as a gas discharge path. The hollow member is provided with a plurality of inlet holes for introducing a gas discharged from the energy storage stacks into the gas discharge path.

### SUMMARY

As the hot gas flows through the gas discharge path, the frame member provided with the gas discharge path becomes hot. If no measure is taken against this, heat may be transferred from the frame member to the energy storage stack adjacent to the frame member, and heat generation may propagate to the energy storage stacks. Since an outlet portion of the gas discharge path is located in a front wall or rear wall of a housing case, the path length to the outlet portion is long, which may cause accumulation of debris in the gas discharge path.

The present disclosure provides an energy storage device that can reduce accumulation of debris and reduce heat transfer between neighboring energy storage stacks.

An energy storage device according to the present disclosure includes:
a housing case having an opening;
an energy storage module disposed in the housing case;
a frame member provided in the housing case so as to cover the opening; and
a cooler configured to cool the energy storage module.
   The energy storage module includes energy storage stacks arranged next to each other. The frame member is disposed between the energy storage stacks arranged next to each other. A gas discharge path communicating with the opening is located inside the frame member. The frame member is provided with an inlet hole configured to introduce a gas discharged from any of the energy storage stacks arranged next to each other into the gas discharge path. The cooler is provided with a through hole at a position corresponding to the opening.

The above configuration allows the gas introduced from the energy storage stack into the gas discharge path located inside the frame member to be directly discharged to the outside of the housing case through the opening of the housing case and the through hole of the cooler. This can reduce the travel distance of the gas, so that the frame member is less likely to become hot. As a result, heat transfer from the frame member to the energy storage stack located on the opposite side of the frame member from the energy storage stack that has generated heat can be reduced, which can reduce thermal propagation between the neighboring energy storage stacks. Since the travel distance of the gas is reduced and debris can also be discharged to the outside through the opening and the through hole, accumulation of the debris in the gas discharge path can also be reduced.

In the energy storage device according to the present disclosure, a discharge valve configured to discharge the gas from the gas discharge path to the outside of the housing case may be provided in either the opening or the through hole.

The above configuration can reduce entry of outside air or foreign matter from outside the energy storage device into the housing case via the through hole of the cooler and the opening of the housing case. The above configuration also allows debris to be discharged to the outside of the energy storage device through the discharge valve.

In the energy storage device according to the present disclosure, the housing case may include a bottom, and the opening may be provided in the bottom.

In the above configuration, the opening and the through hole are provided right under the gas discharge path. This allows debris to be efficiently discharged to the outside.

The present disclosure can provide an energy storage device that can reduce accumulation of debris and reduce heat transfer between neighboring energy storage stacks.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle according to a first embodiment;

FIG. 2 is an exploded perspective view of an energy storage device according to the first embodiment;

FIG. 3 is a schematic sectional view showing a state in which the energy storage device according to the first embodiment is mounted; and

FIG. 4 is an exploded perspective view of an energy storage device according to a second embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

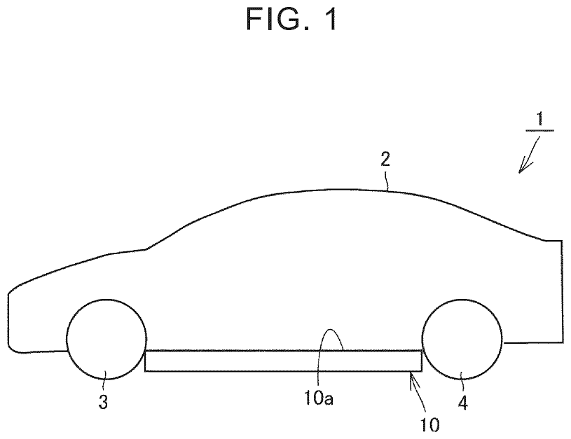

FIG. 1 is a schematic diagram illustrating a vehicle according to a first embodiment. The vehicle 1 according to the first embodiment will be described with reference to FIG. 1.

The vehicle 1 is a hybrid electric vehicle that can travel by using power of either or both of a motor and an engine, or an electrified vehicle that travels by a driving force obtained by electric energy.

The vehicle 1 includes a vehicle body 2, a front wheel 3, a rear wheel 4, and an energy storage device 10. The vehicle body 2 includes a skeleton member 5. The energy storage device 10 is disposed below the vehicle body 2. The energy storage device 10 is disposed, for example, between the front wheel 3 and the rear wheel 4. Note that a part of the energy storage device 10 may be disposed so as to overlap either or both of the front wheel 3 and the rear wheel 4 when viewed from the width direction of the vehicle 1. The energy storage device 10 has an upper surface 10a. The upper surface 10a may function as a floor member defining the interior of the vehicle.

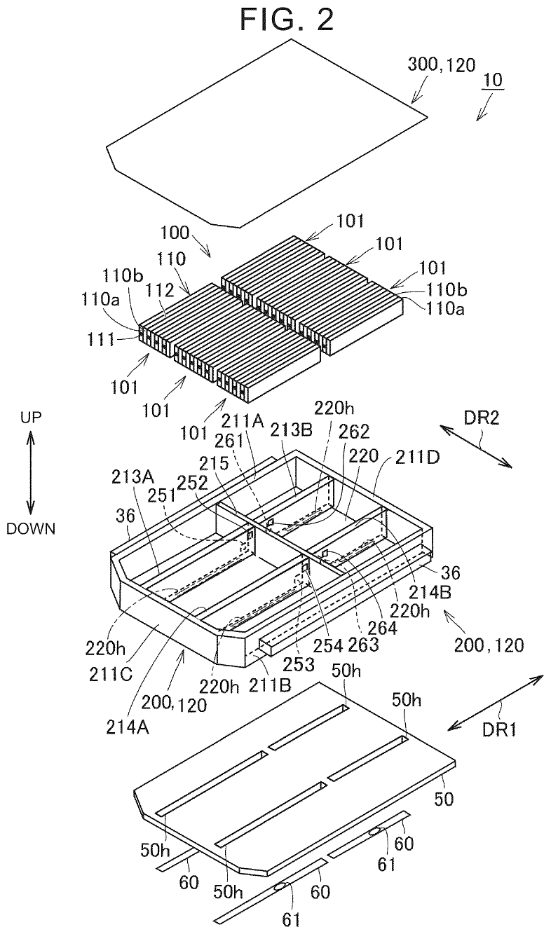

FIG. 2 is an exploded perspective view of an energy storage device according to the first embodiment. The details of the energy storage device 10 according to the first embodiment will be described with reference to FIG. 2.

As shown in FIG. 2, the energy storage device 10 includes an energy storage module 100, a housing case 120, a cooler 50, and a plurality of seal members 60. The energy storage module 100 includes a plurality of energy storage stacks 101 and is housed in the housing case 120.

The energy storage module 100 includes a plurality of energy storage stacks 101. The plurality of energy storage stacks 101 is arranged in a matrix. When the first direction (DR1) is a column direction and the second direction (DR2) is a row direction, the plurality of energy storage stacks 101 is arranged in three rows by two columns, for example. The first direction is, for example, parallel to the front-rear direction of the vehicle 1 in a mounted state in which the energy storage device 10 is mounted on the vehicle body 2. The second direction is orthogonal to the first direction. The second direction is parallel to the left-right direction of the vehicle 1 in the mounted state. The plurality of energy storage stacks 101 is electrically connected in series.

Each energy storage stack 101 includes a plurality of unit cells 110. In each of the energy storage stacks 101, the plurality of unit cells 110 is arranged in the second direction. The plurality of unit cells 110 is electrically connected in series.

The unit cell 110 has a longitudinal shape having a first direction as a longitudinal direction. The unit cell 110 has a flat rectangular parallelepiped shape having a thickness in the second direction.

The unit cell 110 includes a housing 112, and one or more electrode bodies are housed in the housing 112.

When a single electrode body is housed in the housing 112, the electrode body has a shape extending in the longitudinal direction. The electrode body may be a laminated electrode body in which a negative electrode sheet, a separator, and a positive electrode sheet are laminated, or may be a wound electrode body in which a negative electrode sheet, a separator, and a positive electrode sheet are wound.

When a plurality of electrode bodies is housed in the housing 112, the plurality of electrode bodies is arranged side by side in the longitudinal direction and are connected in series. Also in this case, the electrode body may be a laminated electrode body or a wound electrode body.

The unit cell 110 is a secondary cell such as a nickel metal hydride cell or a lithium-ion cell. The unit cell 110 may be a liquid electrolyte or a solid electrolyte. The unit cell 110 may be a chargeable/dischargeable capacitor.

The housing 112 is made of, for example, a metal material such as aluminum. The housing 112 includes a first end face 110a, a second end face 110b, and a discharge valve 111 that are arranged in the first direction. The discharge valve 111 is formed on the first end face 110a. The discharge valve 111 opens when the internal pressure of the housing 112 exceeds a predetermined value, and discharges the gas in the housing 112 to the outside of the housing 112.

In each of the energy storage stacks 101, the plurality of unit cells 110 is arranged in the second direction such that the discharge valves 111 are alternately positioned on one side in the first direction and the other side in the first direction. That is, the plurality of unit cells 110 is arranged such that the first end face 110a and the second end face 110b are alternately arranged in the second direction on one side and the other side in the first direction.

The housing case 120 includes an upper member 300 and a lower case 200. In the present embodiment, the upper member 300 is formed of a plate-like member and functions as a top plate portion. The upper member 300 closes the opening of the lower case 200. The upper member 300 is positioned above the plurality of energy storage stacks 101.

Note that the upper member 300 is not limited to a plate shape, and may be substantially in a box shape that is open downward. In this case, the upper member 300 includes a top plate portion and a peripheral wall extending downward from an outer peripheral edge portion of the top plate portion.

The lower case 200 is substantially in a box shape that is open upward. The lower case 200 includes a bottom 220, a pair of side walls 211A, 211B, a pair of end walls 211C, 211D, and a plurality of frame members 213A, 213B, 214A, 214B, and 215.

The bottom 220 is disposed to face the upper member 300 in the up-down direction. The bottom 220 is provided with a plurality of openings 220h. The plurality of openings 220h is provided at positions corresponding to the plurality of frame members 213A, 213B, 214A, and 214B described later. The plurality of openings 220h extends in the first direction. The pair of side walls 211A, 211B and the pair of end walls 211C, 211D stand upward from the peripheral edge of the bottom 220 and constitute the peripheral wall of the lower case 200.

The lower case 200 includes a body portion 35 and a fixed portion 36. The body portion 35 is constituted by the peripheral wall and the bottom 220. The fixed portion 36 is provided on both side surfaces of the body portion 35 in the second direction. The fixed portion 36 extends in the first direction. As will be described later, the fixed portion 36 is a portion fixed to the vehicle body 2.

The pair of side walls 211A, 211B is arranged in the second direction. The pair of side walls 211A, 211B extends in the first direction. The pair of end walls 211C, 211D is arranged in the first direction. The pair of end walls 211C, 211D extends in the second direction.

The frame member 215 is formed to extend in the second direction on the upper surface of the bottom 220. The frame member 215 divides the space in the housing case 120 in the first direction. The frame member 215 may be formed in a hollow shape or in a solid shape. When the frame member 215 is formed hollow, the frame member 215 has a pair of main walls arranged in the first direction and an upper wall connecting the upper ends of the pair of main walls, and a hollow portion is provided between the pair of main walls.

Each of the plurality of frame members 213A, 213B, 214A, and 214B is disposed between two energy storage stacks 101 located next to each other in the second direction. Each of the plurality of frame members 213A, 213B, 214A, and 214B extends in the first direction.

The frame members 213A, 214A are disposed in a space on one side in the first direction in the housing case 120 partitioned by the frame member 215.

The frame members 213A, 214A are disposed between the pair of side walls 211A, 211B on one side in the first direction. The frame members 213A, 214A are spaced apart from the pair of side walls 211A, 211B and spaced apart from each other in the second direction.

The frame members 213A, 214A divide the space in the housing case 120 located on one side in the first direction from the frame member 215 in the second direction. Specifically, the frame members 213A, 214A divide the space on one side in the first direction in the housing case 120 into three spaces in the second direction. In a space in the housing case 120 located on one side in the first direction, the energy storage stacks 101 are arranged in three regions framed by the frame member 213A, 214A.

The frame members 213B, 214B are disposed in a space on the other side in the first direction in the housing case 120 partitioned by the frame member 215.

The frame members 213B, 214B are disposed between the pair of side walls 211A, 211B on the other side in the first direction. The frame members 213B, 214B are spaced apart from the pair of side walls 211A, 211B and spaced apart from each other in the second direction.

The frame members 213B, 214B divide the space in the housing case 120 located on the other side in the first direction than the frame member 215 in the second direction. Specifically, the frame members 213B, 214B divide the space in the housing case 120 on the other side in the first direction into three spaces in the second direction. In a space in the housing case 120 located on the other side in the first direction, the energy storage stacks 101 are arranged in three regions framed by the frame members 213A, 214A.

Each of the plurality of frame members 213A, 213B, 214A, and 214B is open toward the bottom 220, and is located in the housing case 120 so as to cover the openings 220h provided corresponding to the frame members. Each of the plurality of frame members 213A, 213B, 214A, and 214B has a pair of main walls arranged in the second direction, and an upper wall connecting upper ends of the pair of main walls to each other. A hollow portion is formed between the pair of main walls, and the hollow portion functions as a gas discharge path. As a result, the gas discharge path is located inside the plurality of frame members 213A, 213B, 214A, and 214B. The gas discharge path is in communication with the opening 220h.

The plurality of frame members 213A, 213B, 214A, and 214B is provided with inlet holes 251 to 254 and 261 to 264 for introducing gases into the gas discharge path.

Specifically, in the frame member 213A, the inlet hole 251 is provided in the main wall located on one side in the second direction out of the pair of main walls, and the inlet hole 252 is provided in the main wall located on the other side in the second direction out of the pair of main walls.

In the frame member 214A, the inlet hole 253 is provided in the main wall located on one side in the second direction out of the pair of main walls, and the inlet hole 254 is provided in the main wall located on the other side in the second direction out of the pair of main walls.

In the frame member 213B, the inlet hole 261 is provided in the main wall located on one side in the second direction out of the pair of main walls, and the inlet hole 262 is provided in the main wall located on the other side in the second direction out of the pair of main walls.

In the frame member 214B, the inlet hole 263 is provided in the main wall located on one side in the second direction out of the pair of main walls, and the inlet hole 264 is provided in the main wall located on the other side in the second direction out of the pair of main walls.

The cooler 50 is a device for cooling the plurality of energy storage stacks 101. The cooler 50 is disposed outside the housing case 120. Specifically, the cooler 50 is disposed below the bottom 220 of the lower case 200. The cooler 50 cools the energy storage module 100 through the bottom 220.

The cooler 50 is made of a metal material such as aluminum, for example. A refrigerant for cooling the plurality of energy storage stacks 101 flows inside the cooler 50. The cooler 50 is provided with a plurality of through holes 50h at positions corresponding to the plurality of openings 220h. The through hole 50h passes through the cooler 50. The part of the cooler 50 around the through hole 50h is vertically welded or the like so that the coolant flowing inside does not leak out.

The plurality of seal members 60 seals the through hole 50h. Each seal member 60 is provided with a discharge valve 61. The discharge valve 61 is opened when the pressure in the gas discharge path becomes equal to or greater than a predetermined value by the gas introduced from the inlet hole. The discharge valve 61 functions as a pressure release valve, and the gas is discharged to the outside from the bottom surface side of the cooler 50 by opening the discharge valve 61.

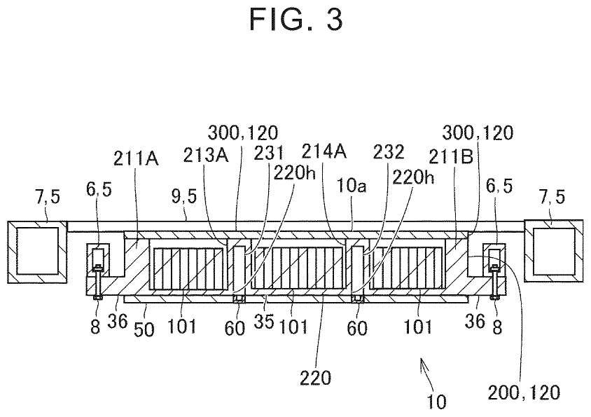

FIG. 3 is a schematic sectional view illustrating a state in which the energy storage device according to the first embodiment is mounted. A state in which the energy storage device according to the first embodiment is mounted will be described with reference to FIG. 3.

As shown in FIG. 3, the vehicle body 2 includes a skeleton member 5. The skeleton member 5 includes a pair of side members 6 and a pair of side sills 7. The pair of side sills 7 is disposed on both end sides in the width direction of the vehicle 1. The pair of side members 6 is disposed inside the pair of side sills 7 at a distance. The pair of side members 6 and the pair of side sills 7 extend in the front-rear direction of the vehicle 1.

The pair of side members 6 is spaced apart in the width direction of the vehicle 1. A body portion 35 of the energy storage device 10 is disposed in a gap between the pair of side members 6. A gap is provided between the body portion 35 and the pair of side members 6. Thus, even when the vehicle 1 collides laterally, it is possible to prevent an impact from being input to the energy storage device 10.

The fixed portion 36 is provided on both side surfaces of the body portion 35 in the width direction of the vehicle 1. The fixed portion 36 is fixed to the pair of side members 6 by the fastening member 8.

The skeleton member 5 also includes a cross member 9. The cross member 9 is provided so as to extend from one side sill 7 to the other side sill 7 above the energy storage device 10. The energy storage device 10 is fastened and fixed to the cross member 9.

In the above description, a case in which the skeleton member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portion 36 may be fixed to the pair of side sills 7.

Reference is now made to FIGS. 2 and 3. In a case where gas is discharged from any of the plurality of energy storage stacks 101 (that is, in a case where any of the plurality of unit cells 110 included in the any of the energy storage stacks generates heat and the gas is discharged), the gas is introduced into the gas discharge path in the frame member from an inlet hole provided in a frame member located adjacent to the energy storage stack. As described above, the through hole 50h of the cooler 50 communicating with the gas discharge path through the opening 220h provided in the bottom 220 is sealed by the seal member 60. When the pressure in the gas discharge path becomes equal to or higher than a predetermined value, the discharge valve 61 is opened, and the gas is discharged from the discharge valve 61 to the outside of the cooler 50.

Specifically, for example, when gas is discharged from the energy storage stack 101 located closest to one side in the second direction out of the three energy storage stacks 101 located on one side in the first direction, the gas is introduced into the gas discharge path 231 in the frame member 213A through the inlet hole 251. When the pressure in the gas discharge path 231 becomes equal to or greater than a predetermined value, the discharge valve 61 corresponding to the gas discharge path 231 is opened. Accordingly, the gas is discharged from the discharge valve 61 to the outside of the energy storage device 10.

When the gas is discharged from the energy storage stack 101 located at the middle in the second direction out of the three energy storage stacks 101 located on one side in the first direction, part of the gas is introduced into the gas discharge path 231 in the frame member 213A through the inlet hole 252. At least a portion of the other gas is introduced into the gas discharge path 232 in the frame member 214A through the inlet hole 253. When the pressure in the gas discharge paths 231, 232 becomes equal to or greater than a predetermined value, the discharge valve 61 corresponding to each gas discharge path is opened, and the gas is discharged from the discharge valve 61 to the outside of the energy storage device 10.

Specifically, for example, when gas is discharged from the energy storage stack 101 located closest to the other side in the second direction out of the three energy storage stacks 101 located on the one side in the first direction, the gas is introduced into the gas discharge path 232 in the frame member 214A through the inlet hole 254. When the pressure in the gas discharge path 232 becomes equal to or greater than a predetermined value, the discharge valve 61 corresponding to the gas discharge path 232 is opened and discharged from the discharge valve 61 to the outside of the energy storage device 10.

When the gas is discharged from any of the three energy storage stacks 101 located on the other side in the first direction, the state in which the gas is discharged is substantially the same as that in the case where the gas is discharged from any of the three energy storage stacks 101 located on the one side in the first direction. Therefore, details of the description will be omitted. Here, the gas is introduced into the gas discharge path located in the frame member 213B or 214B from the inlet holes 261, 262 provided in the frame member 213B or 263, 264 provided in the frame member 214B.

As described above, in the present embodiment, when the gas is discharged from any of the energy storage stacks 101 arranged next to each other, the gas is introduced into the gas discharge path located in the frame member from the inlet hole provided in the frame member disposed between the energy storage stacks 101 arranged next to each other. The gas is discharged to the outside of the energy storage device 10 from the discharge valve 61 provided in the through hole 50h of the cooler 50 communicating with the opening 220h provided in the bottom 220.

As described above, the gas introduced into the frame member is discharged from the discharge valve 61 facing the gas discharge path at a short distance, so that it is possible to prevent the frame member from becoming hot. As a result, heat transfer from the frame member to the energy storage stack located on the opposite side of the frame member from the energy storage stack that has generated heat can be reduced, which can reduce thermal propagation between the neighboring energy storage stacks.

Further, the opening 220h and the through hole 50h are shortened from the inlet hole of the frame member, and debris can also be discharged to the outside from the discharge valve. Thus, the accumulation of debris in the gas discharge path can also be suppressed. In addition, since the opening 220h and the through hole 50h are provided directly under the gas discharge path, debris can be efficiently discharged to the outside.

As described above, in the energy storage device 10 according to the present embodiment, it is possible to reduce accumulation of debris and reduce heat transfer between the neighboring energy storage stacks 101.

Further, the discharge valve 61 is provided in the through hole 50h of the cooler 50. As a result, it is possible to prevent the outside air or foreign matter outside the housing case 120 from entering into the housing case 120 through the through hole 50h of the cooler 50 and the opening 220h provided in the bottom 220.

### Second Embodiment

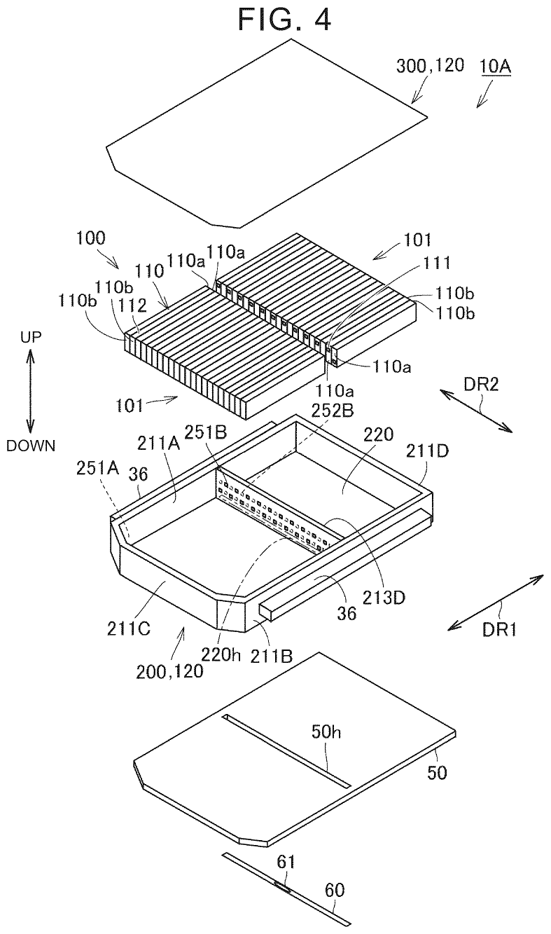

FIG. 4 is an exploded perspective view of an energy storage device according to a second embodiment. Referring to FIG. 4, an energy storage device 10A according to the second embodiment will be described.

As shown in FIG. 4, in the energy storage device 10A according to the second embodiment, the configuration of the housing case 120 and the cooler 50 and the number and arrangement of the energy storage stacks 101 are mainly different from those of the energy storage device 10 according to the first embodiment. The other configurations are substantially the same.

In the energy storage device 10A according to the second embodiment, the two energy storage stacks 101 are spaced apart from each other in the first direction, and the frame member 213D is disposed between the two energy storage stacks 101.

In the energy storage stack 101 located on one side in the first direction, the plurality of unit cells 110 is arranged in the second direction such that the first end faces 110a of the plurality of unit cells 110 included in the energy storage stack 101 face the other side in the first direction. That is, the discharge valves 111 provided in the plurality of unit cells 110 faces the frame member 213D. The plurality of discharge valves 111 is arranged in the second direction in a state of being alternately shifted in the up-down direction.

In the energy storage stack 101 located on the other side in the first direction, the plurality of unit cells 110 is arranged in the second direction such that the first end faces 110a of the plurality of unit cells 110 included in the energy storage stack 101 face the one side in the first direction. That is, the discharge valves 111 provided in the plurality of unit cells 110 face the frame member 213D. The plurality of discharge valves 111 is arranged in the second direction in a state of being alternately shifted in the up-down direction.

The frame member 213D is disposed substantially at the middle of the bottom 220 in the first direction. The frame member 213D extends along the second direction. The frame member 213D is provided so as to cover the opening 220h provided in the bottom 220. The opening 220h extends in the second direction.

A gas-flowable gas discharge path is provided inside the frame member 213D, and the gas discharge path communicates with the opening 220h. The frame member 213D has a pair of main walls opposed to each other in the first direction at a distance from each other, and an upper wall connecting upper ends of the pair of main walls, and a gas discharge path is positioned between the pair of main walls.

The frame member 213D is provided with a plurality of inlet holes 251B, 252B. The plurality of inlet holes 251B is provided in the main wall located on one side of the pair of main walls in the first direction. The plurality of inlet holes 251B is open toward an area where the energy storage stacks 101 located on one side in the first direction are disposed. The plurality of inlet holes 251B is arranged in the second direction while being alternately shifted in the up-down direction, and faces the plurality of discharge valves 111 provided in the energy storage stacks 101 located on one side in the first direction.

The plurality of inlet holes 252B is provided in the main wall located on the other of the pair of main walls in the first direction. The plurality of inlet holes 252B is open toward an area where the energy storage stacks 101 located on the other side in the first direction are disposed. The plurality of inlet holes 252B is arranged in the second direction while being alternately shifted in the up-down direction, and faces the plurality of discharge valves 111 provided in the energy storage stack 101 located on the other side in the first direction.

When the gas is discharged from any of the two energy storage stacks 101, the gas is introduced into the gas discharge path from any of the inlet holes 251B, 252B opened toward the area where the energy storage stack 101 for discharging the gas is disposed. When the pressure in the gas discharge path becomes equal to or greater than a predetermined value, the discharge valve 61 is opened, and the gas introduced into the gas discharge path is discharged from the discharge valve 61 to the outside of the energy storage device 10.

Even with the configuration as described above, the energy storage device 10A according to the second embodiment has substantially the same advantages as the energy storage device 10 according to the first embodiment.

Note that, in each of the energy storage stacks 101, the plurality of unit cells 110 may be arranged in the second direction such that the discharge valves 111 are alternately positioned on one side in the first direction and the other side in the first direction, as in the first embodiment.

### OTHER VARIATIONS

In the first and second embodiments described above, the seal member 60 for sealing the through hole 50h of the cooler 50 has been described by way of example, but the present disclosure is not limited thereto, and the seal member 60 may be omitted. In this case, gases and debris are discharged from the opening 220h and the through hole 50h to the outside of the energy storage device.

The number of the plurality of energy storage stacks 101 is not limited to the number described in the first and second embodiments. The number of the plurality of energy storage stacks 101 can be appropriately changed as long as a frame member in which a gas discharge path is provided between energy storage stacks arranged next to each other and an opening 220h and a through hole 50h are provided in the bottom 220 and the cooler 50 so as to communicate with the gas discharge path.

In the first and second embodiments described above, the discharge valve 61 is provided in the through hole 50h of the cooler 50 as an example, but the discharge valve 61 may be provided in the opening 220h. In addition, when the discharge valve 61 is provided on the opening 220h, the cooler 50 may be disposed between the bottom 220 and the energy storage module 100. Further, although the case where the opening 220h is provided in the bottom 220 has been described as an example, the present disclosure is not limited thereto, and the opening 220h may be provided in the upper member 300. In this case, the frame members are formed to open upward and cover the opening 220h. The cooler 50 may be provided between the upper member 300 and the energy storage module 100, or may be disposed above the upper member 300.

The embodiments disclosed herein are illustrative and not restrictive in all respects. The scope of the present disclosure is defined by the claims, and includes all modifications within the meaning and range equivalent to the claims.

What is claimed is:

1. An energy storage device comprising:
a housing case having an opening;
an energy storage module disposed in the housing case;
a frame member provided in the housing case so as to cover the opening; and
a cooler configured to cool the energy storage module, wherein:
the energy storage module includes energy storage stacks arranged next to each other;
the frame member is disposed between the energy storage stacks arranged next to each other;
a gas discharge path communicating with the opening is located inside the frame member;
the frame member is provided with an inlet hole configured to introduce a gas discharged from any of the energy storage stacks arranged next to each other into the gas discharge path; and
the cooler is provided with a through hole at a position corresponding to the opening.

2. The energy storage device according to claim 1, wherein a discharge valve configured to discharge the gas from the gas discharge path to outside of the housing case is provided in either the opening or the through hole.

3. The energy storage device according to claim 1, wherein:
the housing case includes a bottom; and
the opening is provided in the bottom.
